(19) United States
(12) Patent Application Publication
(10) Pub. No.: US 2026/0009560 A1
(43) Pub. Date: Jan. 8, 2026

(54) NOISE REDUCING MUFFLER DEVICE FOR RADON MITIGATION SYSTEMS

(71) Applicant: Jourdan Dunn, Dayton, OH (US)

(72) Inventor: Jourdan Dunn, Dayton, OH (US)

(21) Appl. No.: 19/326,918

(22) Filed: Sep. 12, 2025

(51) Int. Cl. F24F 13/24; G10K 11/16

(52) U.S. Cl. CPC F24F 13/24; G10K 11/16; F24F 2013/242

(57) ABSTRACT

A muffler device for use in a radon mitigation system is provided. The device includes a cage, preferably of diamond shape, wrapped with a foam layer and inserted into a surrounding pipe. The foam is sandwiched between the cage and the interior wall of the pipe to attenuate noise generated by airflow through the system. Reducer fittings are secured to the interior wall of the pipe and butt against the ends of the cage to retain the assembly in place. The muffler is designed to directly connect to standard PVC piping without requiring additional fittings. The invention enables easy installation by sliding over the outlet vent and provides effective sound suppression while maintaining airflow efficiency.

### TECHNICAL FIELD

The present invention relates generally to radon mitigation systems, and more particularly, to noise reducing muffler devices designed for installation on the outlet vents of radon mitigation systems.

### BACKGROUND

Radon is a naturally occurring radioactive gas that can accumulate in buildings, particularly in basements and lower levels. Long-term exposure to elevated radon levels poses serious health risks, including lung cancer. To mitigate these risks, radon mitigation systems are commonly installed in residential and commercial structures. These systems typically include a vent pipe and an exhaust fan that draws radon-laden air from beneath the building and expels it above the roofline, where it can safely dissipate into the atmosphere.

While effective in reducing radon concentrations, these mitigation systems often generate undesirable noise, particularly at the outlet vent where high-speed airflow and fan operation can produce whistling, vibration, and other acoustic disturbances. This noise can be bothersome to homeowners and neighbours, especially when the outlet vent is located near living spaces, windows, or outdoor areas.

Conventional attempts to address this issue have involved adding generic mufflers, silencers, or sound baffles to the outlet vent. However, such solutions typically require complex installation procedures, use bulky add-on components, or interfere with airflow, reducing the overall efficiency of the radon mitigation system. Moreover, many commercial mufflers are not designed to integrate seamlessly with standard PVC piping used in residential installations.

Several solutions have been proposed in the prior art for noise reduction in radon mitigation systems. One of the prior arts, U.S. Pat. No. 11,402,123 B2 discloses a silencer for an in-line vent fan, which incorporates an elongated housing with internal baffles and sound-absorbing insulation to reduce noise generated by airflow. The focus of this invention is on in-line noise suppression within the fan or duct path, involving more complex internal chambers and flow redirection. Another prior art, U.S. Patent Application US 2024/0255176 A1 describes a radon vent silencer that uses an elongated body with internal perforated tubing and sound-dampening material to attenuate fan and airflow noise. Both inventions are intended to be installed in-line with the ductwork or piping system, requiring more elaborate assemblies and potentially more invasive installation.

There exists a need for a simple, cost-effective, and efficient noise-reducing device that can be easily installed on a radon mitigation system without compromising airflow or requiring substantial modification of existing infrastructure.

### SUMMARY

It will be understood that this disclosure is not limited to the particular systems, and methodologies described, as there can be multiple possible embodiments of the present disclosure which are not expressly illustrated in the present disclosure. It is also to be understood that the terminology used in the description is to describe the particular versions or embodiments only and is not intended to limit the scope of the present disclosure.

In an embodiment, the present invention relates to a muffler device for a radon mitigation system. The system includes a cage configured to be inserted into and aligned with an outlet vent of the radon mitigation system. Further, the muffler device includes a foam layer wrapped around an outer surface of the cage, the foam layer being sandwiched between the cage and an interior surface of a surrounding pipe to attenuate sound and vibration. Further, the muffler device includes one or more reducer fittings secured to an inner wall of the pipe, wherein the one or more reducer fittings butt against opposing ends of the cage to hold the cage and foam layer in place, wherein the muffler device is configured to directly connect to the surrounding pipe without additional fittings.

In an embodiment, the cage has a diamond-shaped cross-section, optimizing airflow and noise reduction. Further, the diamond shape of the cage enhances turbulence dispersion, thereby improving noise reduction without significantly impeding airflow. Additionally, the cage has an alternative geometry selected from a group consisting of cylindrical, hexagonal, and oval shapes to achieve desired airflow characteristics. In addition, the cage is formed from a corrosion-resistant metal or rigid plastic mesh to maintain structural integrity within the vent.

In an embodiment, the foam layer comprises an open-cell acoustic foam, a multi-layer composite foam, or a fiberglass insulation material. Further, the foam layer is adhesively bonded to the outer surface of the cage to prevent displacement during installation or operation.

In an embodiment, one or more reducer fittings adhesively bonded to the surrounding pipe to secure the muffler assembly.

In an embodiment, the muffler device is configured as a slip-fit assembly allowing installation by sliding the muffler over the outlet vent without specialized tools. Further, the muffler device includes a removable end cap configured to allow periodic inspection or replacement of the foam layer.

These and other features and advantages of the present invention will become apparent from the detailed description below, in light of the accompanying drawings.

### BRIEF DESCRIPTION OF THE DRAWINGS

FIG. 1 illustrates a perspective view of a muffler device for a radon mitigation system, according to an exemplary embodiment of the present invention;

FIG. 2 illustrates an exploded view showing various components of the muffler device, including the internal cage, foam layer, and reducer fittings, according to an embodiment of the present invention;

FIG. 3 illustrates a sectional view disclosing the assembled relationship between the cage and the reducer fittings, and surrounding pipe, in accordance with one embodiment of the present invention;

FIG. 4 illustrates the internal structure of the cage, according to an embodiment of the present invention;

FIG. 5 illustrates the muffler device connected in-line along the vent pipe of a radon mitigation system, according to an embodiment of the present invention;

FIG. 6 illustrates the muffler device connected at the extreme end of the vent pipe of the radon mitigation system, according to an embodiment of the present invention; and

FIGS. 7A and 7B illustrate a side-by-side comparison of a vent pipe without the muffler and a vent pipe with the muffler installed, according to an exemplary embodiment of the present invention.

### DETAILED DESCRIPTION

As used in the specification, the singular forms “a”, “an” and “the” may also include plural references. For example, the term “an article” may include a plurality of articles. Those with ordinary skill in the art will appreciate that the elements in the figures are illustrated for simplicity and clarity and are not necessarily drawn to scale. There may be additional components or processes described in the foregoing application that are not depicted on the described drawings. In the event, such a component or process is described, but not depicted in a drawing, the absence of such component and process from the drawings should not be considered as an omission of such design from the specification.

Before describing the present invention in detail, it should be observed that the present invention utilizes a combination of components or processes, which constitutes a muffler device for a radon mitigation system. Accordingly, the components or processes have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific component-level details and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment. The words “comprising”, “having”, “containing”, and “including”, and other forms thereof, are intended to be equivalent in meaning and be open-ended in that an item or items following any one of these words is not meant to be an exhaustive listing of such item or items or meant to be limited to only the listed item or items. Further, the words “user”, “installer”, “technician”, “contractor”, “homeowner”, and “person” are used interchangeably in the description.

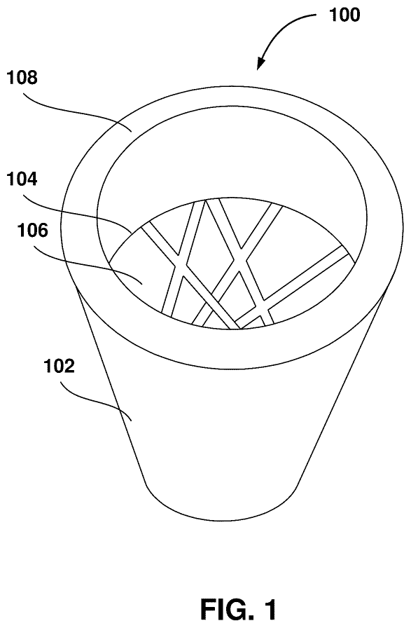

A muffler device for a radon mitigation system will now be described with reference to the accompanying drawings, particularly FIGS. 1-7.

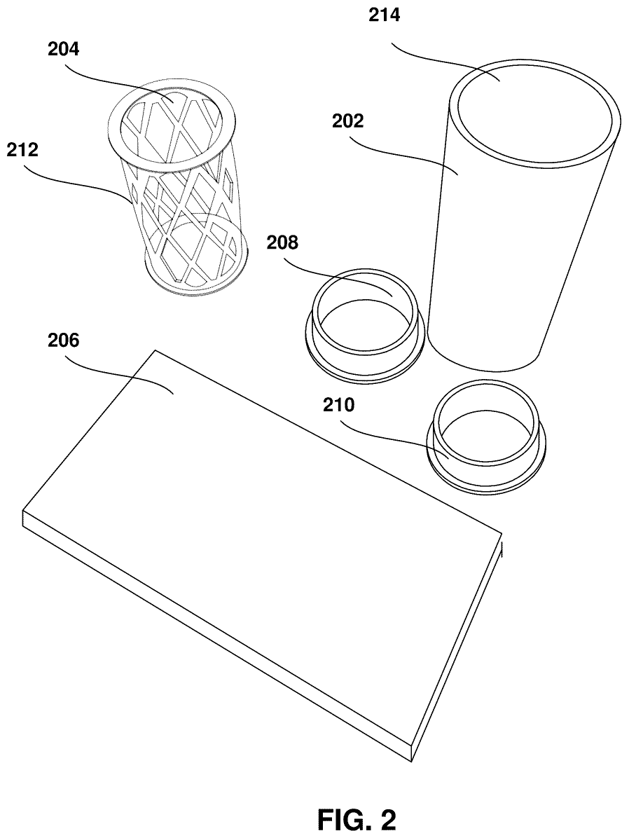

Referring to FIG. 1 in conjunction with FIGS. 2-7, the muffler device for the radon mitigation system is shown. In the embodiment, the muffler device 100 is configured to be mounted onto or integrated with the outlet vent pipe of the radon mitigation system (not shown) to reduce the noise produced by air movement and fan operation. The muffler device 100 is a compact, passive silencing unit designed for easy installation and compatibility with standard PVC piping used in residential radon mitigation systems.

The muffler device 100 comprises a pipe 102, which is typically made from PVC or a similar rigid, weather-resistant plastic material. The pipe 102 is dimensioned to slide over or connect in line with the radon vent pipe. The pipe 102 encloses a diamond-shaped internal cage 104, which functions as the primary structural element for directing airflow and attenuating acoustic disturbances generated within the system. The cage 104 is preferably formed of a mesh material or perforated structure and may be fabricated from corrosion-resistant metals such as aluminium or stainless steel, or a durable thermoplastic.

Further, a foam layer 106 is wrapped around the cage 104 that serves as the primary sound-absorbing medium. The foam 106 is preferably an open-cell acoustic foam engineered to dampen the high-frequency noise generated by turbulent airflow. The foam layer 106 is dimensioned to tightly fit between the outer surface 212 of the cage 104 (as shown in FIG. 2) and the inner wall 214 of the pipe 102 (as shown in FIG. 2). In other words, the foam layer 106 is effectively sandwiched between the cage 104 and the inner wall of the pipe 102. The foam layer 106 is held firmly in place by the tight fit between components, and adhesive may be used to further prevent movement during system operation.

In an embodiment, on either end of the muffler device 100, reducer fittings, for example, reducer fitting 108 is mounted to retain the internal cage 104 and foam assembly within the housing 102. The reducer fittings are designed to butt up against the ends of the cage 104, holding the cage 104 firmly in place without allowing longitudinal movement. The reducer fittings may be glued to the interior surface/internal wall 214 of the pipe 102 using a standard PVC adhesive, ensuring a secure and leak-resistant seal.

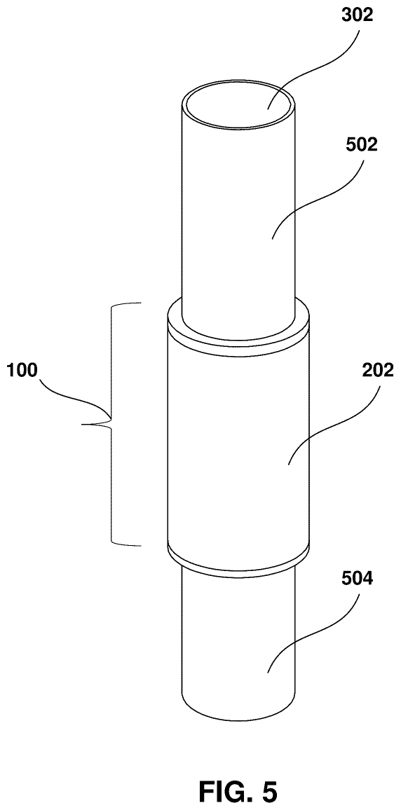

In an embodiment, the muffler device 100 is designed to slide directly over the outlet vent pipe 302 as shown in FIG. 5 of the radon mitigation system, eliminating the need for additional fittings or tools. This slip-fit design allows for fast and easy installation, making it ideal for residential applications where minimal disruption is desired. In the context of the present invention, tools refer to task-specific or professional-grade equipment typically required for installing traditional mufflers or vent silencers such as pipe threading machines, welding tools, crimping devices, or acoustic baffle placement tools. These tools often demand skilled operation and are not commonly found in residential or general contractor toolkits. In contrast, the muffler device 100 is designed as a slip-fit assembly, allowing it to be installed simply by sliding it over the outlet vent pipe without the need for such specialized tools. Basic items like a standard PVC pipe cutter and optional PVC adhesive are sufficient for installation.

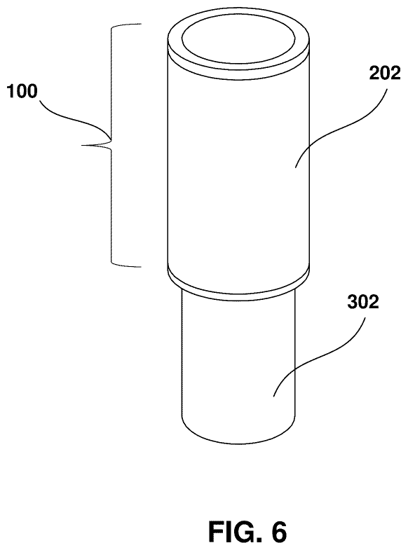

In an example, a homeowner/user is able to install the muffler device 100 at the termination point of a vertical radon vent pipe exiting above the roofline, as shown in FIG. 6. The muffler device 100 simply slides onto the vertical radon vent pipe and is secured using PVC cement or friction fit. Upon installation, the muffler device 100 immediately reduces the audible hum and vibration generated by the system's inline fan, without compromising the airflow required for effective radon gas evacuation.

In another example, the muffler device 100 is installed in-line between two sections of PVC pipe (i.e., vertical radon vent pipe) using the reducer fittings as couplers as shown in FIG. 5, thus integrating seamlessly into the existing pipe run. This configuration may be preferable in systems where the outlet is flush with a wall or soffit, and end-of-pipe access is limited.

In an embodiment depicted in FIG. 2, the muffler device 100 is shown in an exploded configuration to clearly illustrate the internal structure and interaction of its primary components. These components include an outer cylindrical pipe 202 (which may form part of the vent pipe or the muffler device housing illustrated as the pipe 102 in FIG. 1), an internal cage 204, a foam layer 206, and opposing reducer fittings 208 and 210.

The outer cylindrical pipe 202 forms the housing of the muffler device 100 and may be constructed from standard PVC piping, allowing for direct compatibility with existing radon mitigation infrastructure. The outer cylindrical pipe 202 defines the internal cavity in which the noise-dampening components are installed. In an embodiment, the internal cage 204 is a rigid structural element having a diamond-shaped cross-section, although other shapes (e.g., cylindrical, hexagonal) may be used in alternate embodiments. The internal cage 204 is preferably made from a corrosion-resistant metal such as aluminium or stainless steel, or from high-strength plastic or composite mesh. The internal cage 204 serves as a scaffold for the foam material while allowing unhindered airflow through its open structure. The diamond geometry has been found particularly effective in disrupting sound wave propagation while maintaining a streamlined path for vented air.

The foam layer 206 is positioned around the outer surface of the cage 204 in such a manner that its inner surface conforms to the shape and dimensions of the cage 204, ensuring uniform contact and minimal gaps between the two components. The foam 206 may be made from open-cell acoustic polyurethane or similar sound-absorbing material. The thickness and density of the foam 206 can be selected based on the desired attenuation characteristics. In one embodiment, the foam 206 is either pre-formed to fit the cage 204 or is applied as a flexible wrap that compresses between the cage 204 and the inner wall of the outer pipe. The foam layer 206 is positioned such that, when installed, it becomes sandwiched between the cage 204 and the inner surface of the outer cylindrical pipe 202, thereby ensuring a tight fit and maximum surface area for acoustic absorption.

In an embodiment, the reducer fittings 208 and 210 are designed to be inserted into opposite ends of the outer cylindrical pipe 202 such that they abut directly against the respective ends of the internal cage 204. The reducer fittings 208 and 210 serve a dual purpose, for example, the reducer fittings 208 and 210 facilitate direct connection to adjoining vent pipe sections of varying diameters and mechanically retain the internal cage 204 and foam layer 206 within the muffler housing, ensuring proper alignment and stability. In some configurations, the reducer fittings 208 and 210 are permanently affixed to wall of the outer cylindrical pipe 202 using PVC adhesive or mechanical locking features such as ridges or grooves.

In one exemplary use case, the components shown in FIG. 2 are pre-assembled into a muffler cartridge and bonded within a 4-inch PVC pipe section. The cage is fabricated from stainless steel mesh with a diamond-patterned frame, and the foam layer is a half-inch thick open-cell acoustic foam. For example, BASOTECT®, Auralex® Studiofoam, SONEX® Classic Panels, and Foamily® Acoustic Panels. The reducer fittings are standard 4-inch to 3-inch PVC reducers that allow the muffler to be installed between two 3-inch vent pipe segments. In another variation, the foam layer 206 is infused with antimicrobial additives to prevent mold growth in humid environments.

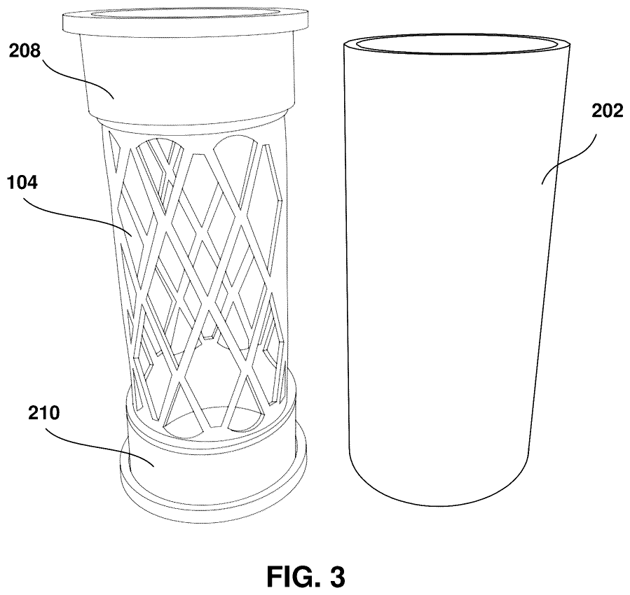

In an embodiment shown in FIG. 3, the muffler device 100 is presented in a fully assembled cross-sectional view of the internal cage 104 and the reducer fittings 208 and 210, providing clear insight into the spatial arrangement and functional integration of the internal cage 104, and the reducer fittings 208 and 210. As shown in FIG. 3, the cage 104, which in this embodiment has a diamond-shaped cross-section designed to enhance airflow characteristics while simultaneously disturbing and diffusing acoustic waves generated by the radon mitigation fan. The cage 104 spans the central length of the outer cylindrical pipe 202 and maintains a central alignment along the pipe's longitudinal axis.

The reducer fittings 208 and 210 may have an internal shoulder or ledge that abuts the ends of the cage 104, thereby locking the cage and foam layer firmly in position. This prevents any longitudinal movement or rattling during operation. In an embodiment, the reducer fittings 208 and 210 are secured using a PVC-compatible adhesive, creating a permanent, sealed bond with the interior wall of the pipe.

In one illustrative example, the muffler device 100 is built using a 4-inch PVC pipe section as the outer cylindrical pipe 202, which encloses the diamond-frame cage 104 made from stainless steel mesh. Two reducer fittings 208 and 210 convert the 4-inch muffler device 100 ends to 3-inch pipe connections. An installer applies PVC adhesive to secure the fittings inside the pipe, causing them to press against the cage ends and complete the assembly. The finished unit is then inserted in line between two 3-inch vertical radon vent pipe sections using solvent welding.

In another embodiment, the cage 104 is made from moulded thermoplastic and the foam is integrally cast around the cage in a production mould, forming a single core insert that is then loaded into the outer cylindrical pipe 202 and locked in place by the reducer fittings 208 and 210. This configuration reduces assembly time and supports high volume manufacturing.

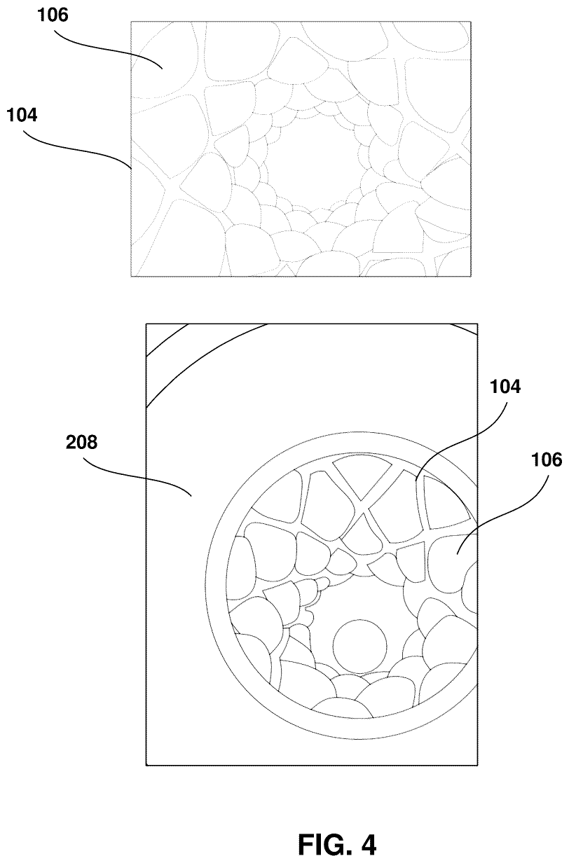

In the embodiment shown in FIG. 4, the internal cage 104 of the muffler device 100 is illustrated in more detail, revealing its structural geometry and functional role within the assembly. The cage 104 is a rigid, open-frame structure, preferably having a diamond-shaped cross-section, although other geometries may be used in alternative embodiments (e.g., circular or hexagonal). This cage 104 functions as the core support element around which the acoustic foam layer is wrapped.

The primary purpose of the cage 104 is to stabilize the acoustic foam 106 during system operation, especially when exposed to constant airflow pressure from the radon mitigation fan. By providing a rigid form inside the muffler device 100, the cage 104 prevents the foam from collapsing inward or shifting longitudinally, thus maintaining consistent spatial orientation and acoustic performance over time. The open-frame structure of the cage 104 is designed to allow unobstructed airflow through its internal volume, with the diamond geometry specifically chosen for its dual advantages, such as aerodynamic flow with minimal backpressure, and acoustic diffusion, wherein the sound waves generated by turbulent airflow are deflected, scattered, or absorbed more effectively by the surrounding foam.

Further, the foam 106 expands outward into the open spaces of the cage frame when airflow pressure is applied. This dynamic interaction between the cage 104 and the foam 106 results in a gentle, self-adjusting compression that enhances the sound attenuation effect without obstructing the air path. Unlike rigid baffled mufflers, the proposed muffler design ensures that system performance, measured in airflow rate and static pressure drop, remains largely unaffected. The cage 104 is constructed from durable, corrosion-resistant materials such as stainless-steel wire mesh, powder-coated aluminium, or injection-moulded thermoplastic. These materials are selected to withstand prolonged exposure to environmental conditions, including humidity and temperature fluctuations common in radon exhaust scenarios.

In one illustrative example, the muffler device 100, including the internal cage 104, is designed for direct integration with 3-inch schedule 40 PVC vent pipes commonly used in residential radon mitigation systems. In this embodiment, the built-in reducer fittings 208 and 210 eliminate the need for separate couplers, enabling the device to connect seamlessly with existing vent pipe segments. This streamlined design not only reduces parts and labour during installation but also results in a compact form factor that minimizes visual impact, an important consideration for residential applications. For example, during a real-world installation, a technician can apply PVC cement to the pipe and slide the muffler in place, with the cage and foam assembly already secured inside the housing. This configuration provides superior noise reduction (typically in the range of 8-12 dB) without reducing radon mitigation system performance.

In the embodiment shown in FIG. 5, the muffler device 100 is depicted as being installed in-line with a vertical segment of the vent pipe 302 of a radon mitigation system. This configuration demonstrates one of the key installation modes of the invention, where the muffler is not placed at the termination point of the pipe 302, but rather inserted as part of the continuous piping run between upstream and downstream pipe sections 502 and 504.

The muffler device 100 consists of the outer cylindrical pipe 202, internally assembled with the acoustic foam layer 106 supported by the internal cage 104 and bounded on either side by reducer fittings 208 and 210. In this in-line configuration, the ends of the muffler housing are joined directly to adjacent segments of the radon vent pipe 302 using solvent welding (PVC cement) or similar bonding methods common to PVC piping systems. This installation approach is particularly well-suited for retrofits, where adding the muffler to an existing system requires minimal modification.

The in-line configuration maintains the same internal diameter (e.g., 3-inch schedule 40 PVC) as the rest of the vent system, thereby preserving the required airflow volume and pressure characteristics necessary for radon evacuation. The integrated muffler assembly may not introduce sharp bends, baffles, or directional changes, ensuring minimal pressure drop and avoiding interference with system compliance. In a typical installation, a contractor cuts a section of the existing vertical vent pipe within a utility space and inserts the muffler device 100 between the cut ends. The reducer fittings 208 and 210 of the muffler are solvent-welded to the cut pipe ends. The internal components, such as the cage 104 and foam 106 are preassembled within the muffler body, and no additional modifications, brackets, or fasteners are needed. The entire process may take less than 10 minutes and requires only standard PVC tools and adhesive. The resulting assembly visibly resembles a slightly enlarged section of vent pipe 302 but significantly reduces the sound level of the system, particularly the fan hum and airflow hiss. For example, noise levels measured at a distance of 10 feet from the pipe were reduced by up to 12 decibels, depending on fan model and system configuration.

In another embodiment, the muffler device 100 is installed horizontally in an attic-mounted system. The in-line connection works identically, and the internal cage structure maintains foam stability regardless of orientation. The muffler device 100 may also be used between two 3-inch elbow joints where the vent pipe 302 changes direction, making it highly adaptable to non-linear pipe layouts.

In the embodiment illustrated in FIG. 6, the muffler device 100 is shown installed at the terminal or extreme end of the radon mitigation vent pipe 302, rather than being integrated in-line with the piping as illustrated in FIG. 5. This configuration is particularly useful in new installations or retrofits where access to the terminal section of the pipe, typically above the roofline or along an exterior wall, is feasible.

The muffler device 100 comprises the same internal components as described in prior embodiments. In this configuration, the reducer fitting 206 at the muffler's inlet end is joined directly to the open end of the vertical radon vent pipe 302, using a slip-fit connection or PVC adhesive to ensure mechanical stability and airtightness. The outlet end of the muffler device remains open to the atmosphere, allowing radon-laden air to be safely discharged after passing through the noise-reducing elements. This end-of-pipe configuration offers a simpler and accessible installation process, requiring no alteration to the rest of the vent system. It also provides maximum opportunity for sound attenuation, as the muffler is placed at the final point of air discharge, where noise is typically most noticeable and problematic.

In one example, a homeowner with an existing radon mitigation system experiences disruptive noise from the exhaust pipe located near a second-story window. The installer cuts no part of the system; instead, they apply PVC cement to the outlet end of the existing pipe and slide the muffler device 100 directly over it. The reducer fitting inside the muffler ensures a snug fit and aligns the internal cage and foam for optimal performance. Upon installation, the muffler immediately reduces the audible hiss and fan vibration noise by several decibels. The compact profile of the device ensures it does not interfere with aesthetics or violate clearance requirements for radon exhaust outlets (e.g., minimum distances from windows or roof edges).

In another embodiment, the end-mounted muffler includes a protective cap or screen on its outlet to prevent debris, insects, or water ingress. The cap is designed with aerodynamic slots or vents that allow air to escape freely while maintaining weather resistance. A further variant includes an integrated condensation drain at the bottom of the muffler housing to handle moisture accumulation from humid airflow or rain, particularly in regions with frequent precipitation.

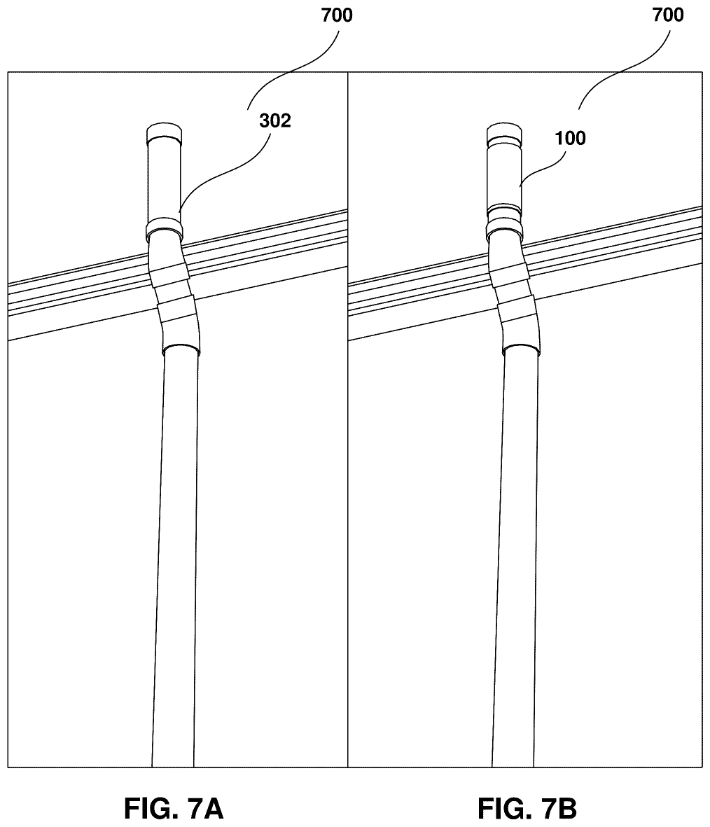

In an embodiment, FIG. 7A-7B illustrates a visual and functional comparison between two configurations of a radon mitigation system 100. One without the muffler device as shown in FIG. 7A and another with the muffler device 100 installed either in-line or at the terminal end as shown in FIG. 7B. This side-by-side depiction is intended to highlight the aesthetic, structural, and acoustic differences between the two systems and to disclose the practical benefits of incorporating the muffler into the radon exhaust setup.

As shown in FIG. 7A, the radon mitigation system 700 is shown in its standard configuration, with a vent pipe 302 extending vertically (e.g., through the roof or along an exterior wall) to release radon-laden air into the atmosphere. In this configuration, the vent pipe is typically connected to a continuously running in-line fan. The system emits a noticeable hum or high-pitched airflow noise, particularly during periods of high fan speed. In the absence of sound-dampening structure, vibrations may resonate along the pipe and radiate outward. The pipe appears utilitarian but exposed and unrefined, which can be a concern in residential or aesthetically sensitive settings.

As shown in FIG. 7B, the same radon mitigation system 700 is shown with the muffler device 100 installed, either in-line or at the end of the vent pipe. This installation demonstrates several clear advantages, such as the muffler assembly encloses the internal foam layer 106 and cage 104, absorbing and disrupting acoustic energy generated by the fan. Further, the system is significantly quieter, reducing ambient noise levels by up to 8-12 decibels in tested scenarios. Further, the muffler device seamlessly blends with standard PVC piping, maintaining a low visual profile. Further, the integrated reducer fittings ensure compatibility with existing pipe diameters (e.g., 3-inch schedule 40 PVC) and eliminate the need for extra couplers, simplifying the installation.

The present invention offers significant advantages by combining continuous health monitoring, secure wearable technology, and an intelligent software platform into a single integrated ecosystem. Unlike conventional wearables that only track basic fitness metrics, this system provides medical-grade monitoring of multiple physiological parameters, real-time geolocation tracking, and proactive safety enforcement. The inclusion of tamper detection, biometric authentication, and a secure locking mechanism ensures that the device remains reliable and compliant in high-security environments such as hospitals, rehabilitation centers, and correctional facilities. Additionally, dynamic geofencing capabilities enhance patient safety by triggering immediate alerts when a user moves outside predefined boundaries, which is particularly beneficial for dementia patients and other vulnerable populations.

In one example, a radon mitigation system installed near a bedroom window produced a persistent humming sound, disturbing the occupant's sleep. After installing the muffler device at the end of the vent pipe (as shown in FIG. 7B), the noise was reduced to an almost imperceptible level without affecting system airflow or requiring professional modification. In another example, a builder seeking to meet both code compliance and noise standards in a high-end residential development specified that all radon systems include the muffler device in-line, ensuring uniform appearance and silent operation across multiple units.

In alternative configurations not limited to FIG. 7, the muffler housing may be painted or finished to match architectural details or roof elements. The system can include decorative end caps or mesh screens for pest control or aesthetic enhancement.

The present invention provides a compact, modular muffler device specifically designed for radon mitigation systems, offering significant noise reduction without compromising airflow performance or requiring complex installation. By integrating a diamond-shaped internal cage, an acoustic foam layer, and built-in reducer fittings, the invention achieves superior acoustic attenuation with minimal pressure drop. The foam is stabilized by the cage structure, which ensures that it remains properly positioned even under constant airflow pressure, while the pillowing effect of the foam enhances its sound-dampening capability. Unlike traditional mufflers that rely on elongated chambers or complex baffles, this design maintains high airflow efficiency and is compatible with standard 3-inch schedule 40 PVC piping.

Another key advantage of the invention lies in its versatility and ease of installation. The muffler can be mounted either in-line within the vent pipe or at the terminal end, using a simple slip-fit or adhesive connection without the need for couplers, specialized tools, or system redesign. This makes it ideal for both new installations and retrofitting existing radon systems in residential and commercial settings. The streamlined appearance preserves visual uniformity, while the internal configuration ensures long-term durability with minimal maintenance. Collectively, these features make the invention a cost-effective, installer-friendly, and highly effective solution for reducing noise pollution in radon mitigation systems.

Although particular embodiments of the invention have been described in detail for purposes of illustration, various modifications and enhancements may be made without departing from the spirit and scope of the invention.

What is claimed is:

1. A muffler device for a radon mitigation system, comprising:
a pipe;
a cage configured to be inserted into and aligned with an outlet vent of the radon mitigation system;
a foam layer wrapped around an outer surface of the cage, the foam layer being sandwiched between the cage and an interior surface of the pipe to attenuate sound and vibration;
one or more reducer fittings secured to an inner wall of the pipe, wherein the one or more reducer fittings butt against opposing ends of the cage to hold the cage and foam layer in place; and
wherein, the muffler device is configured to connect to the pipe without additional fittings.

2. The muffler device of claim 1, wherein the cage comprises a diamond-shaped cross-section, optimizing airflow and noise reduction.

3. The muffler device of claim 2, wherein the diamond shape of the cage enhances turbulence dispersion, thereby improving noise reduction without significantly impeding airflow.

4. The muffler device of claim 1, wherein the cage has an alternative geometry selected from a group consisting of cylindrical, hexagonal, and oval shapes to achieve desired airflow characteristics.

5. The muffler device of claim 1, wherein the cage is formed from a corrosion-resistant metal or rigid plastic mesh to maintain structural integrity within the vent.

6. The muffler device of claim 1, wherein the foam layer comprises an open-cell acoustic foam, a multi-layer composite foam, or a fiberglass insulation material.

7. The muffler device of claim 1, wherein the foam layer is adhesively bonded to the outer surface of the cage to prevent displacement during installation or operation.

8. The muffler device of claim 1, wherein one or more reducer fittings adhesively bonded to the pipe to secure the muffler assembly.

9. The muffler device of claim 1, wherein the muffler device is configured as a slip-fit assembly allowing installation by sliding the muffler over the outlet vent without specialized tools.

10. The muffler device of claim 1 further comprising a removable end cap configured to allow periodic inspection or replacement of the foam layer.

11. A method of installing a muffler device for reducing noise in a radon mitigation system, the method comprising:
sliding the muffler device assembly over an outlet vent of the radon mitigation system;
positioning a cage having a diamond shape within a pipe;
wrapping a foam layer around an outer surface of the cage such that the foam layer is sandwiched between the cage and an interior wall of the pipe;
securing reducer fittings to the interior wall of the pipe such that the reducer fittings butt against opposing ends of the cage; and
directly connecting the muffler device assembly to the surrounding piping without requiring additional fittings.

12. The method of claim 11, wherein the step of securing the reducer fittings comprises gluing the fittings to the interior wall of the pipe using a PVC-compatible adhesive.

13. The method of claim 11, wherein the foam layer is pre-bonded to the cage prior to installation to simplify assembly.

14. The method of claim 11, wherein the diamond shape of the cage is selected to maximize airflow while minimizing noise attenuation loss.

15. The method of claim 11 further comprising periodically removing an end cap to inspect or replace the foam layer.

16. A radon mitigation system comprising:
a vent pipe configured to discharge radon-laden air from a building;
a fan assembly coupled to the vent pipe to draw air through the radon mitigation system, and
a muffler device installed on the outlet vent, wherein the muffler device comprising:
a cage configured to be inserted into and aligned with an outlet vent of the radon mitigation system;
a foam layer wrapped around an outer surface of the cage, the foam layer being sandwiched between the cage and an interior surface of a pipe to attenuate sound and vibration;
one or more reducer fittings secured to an inner wall of the pipe, wherein the one or more reducer fittings butt against opposing ends of the cage to hold the cage and foam layer in place;
wherein the muffler device is configured to connect to the pipe without additional fittings; and
wherein the muffler device reduces operational noise while maintaining airflow efficiency.
